(19) United States
(12) Patent Application Publication
(10) Pub. No.: US 2010/0077722 A1
(43) Pub. Date: Apr. 1, 2010

(54) PEAK LOAD MANAGEMENT BY COMBINED CYCLE POWER AUGMENTATION USING PEAKING CYCLE EXHAUST HEAT RECOVERY

(75) Inventors: Ajit Singh Sengar, Bangalore (IN); Saravanan Venkataraman Nattanmai, Chennai (IN); Shivaprasad Lokanath, Mangalore (IN)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/242,863

(22) Filed: Sep. 30, 2008

(51) Int. Cl. F01K 23/10; F02C 6/18

(52) U.S. Cl. 60/39.182; 60/653; 60/670

(57) ABSTRACT

Systems and methods for augmenting the power generation capabilities of combined cycle power generation systems by more effectively recovering heat from exhaust gases of peaking cycle gas turbines are provided in the disclosed embodiments. In certain embodiments, the present techniques may include receiving superheated steam from a heat recovery steam generation (HRSG) unit. Heated exhaust gas from a peaking cycle gas turbine may be used to transfer heat to the superheated steam received from the HRSG. The systems used to transfer heat to the superheated steam may include a supplementary superheater located in an exhaust path of the peaking cycle gas turbine. The superheated steam exiting the supplementary superheater may be delivered to a steam turbine of a combined cycle power generation system, where the superheated steam may be used as a power source. Optionally, a peaking cycle attemperator may be used to ensure that the temperature of the superheated steam delivered to the steam turbine does not exceed a predetermined temperature level, thereby protecting the steam turbine and associated equipment.

### BACKGROUND OF THE INVENTION

The present invention relates generally to heat recovery systems. More specifically, the invention relates to systems and methods for augmenting the power generation capabilities of combined cycle power generation systems by more effectively recovering heat from exhaust gases from peaking cycle gas turbines.

Peak loading systems, such as peaking cycle gas turbines, may be used as supplementary power sources during peak load periods when the total power required from power generation systems, such as combined cycle power generation systems, become too great for the main power generation systems to handle efficiently. The increasing demand for peak loads during heavy operating hours has served to magnify the importance of operating efficiencies of peaking cycle units. Furthermore, increasing competition in the peaking cycle segment of the power generation industry has made these efficiency considerations even more important design criteria.

Typical peaking cycle units which utilize gas turbines may simply vent heated exhaust gases discharged from the gas turbines. However, in doing so, the energy from the heated exhaust gases is not recaptured. In fact, in many of these systems, the heated exhaust gases may require cooling before being vented. This cooling requirement often reduces the overall peaking cycle efficiency because energy may be required to cool the exhaust gas. In addition, the processes used to reduce emissions from the heated exhaust gases in many instances may be less reliable and more expensive when the temperatures of the exhaust gases are higher. Therefore, effective recovery of heat from the exhaust gases from peaking cycle gas turbines may improve the overall efficiencies of both the peaking cycle and combined cycle power generation systems, while also providing other tangential benefits.

### BRIEF DESCRIPTION OF THE INVENTION

In one embodiment, a method for recovering exhaust heat from a gas turbine is provided. The method includes receiving superheated steam from a low-pressure evaporator of a heat recovery steam generation unit. The method also includes transferring heat from an exhaust gas of a gas turbine to the superheated steam received from the low-pressure evaporator using a low-pressure supplementary superheater in an exhaust path of the gas turbine. The method further includes delivering the superheated steam to a low-pressure stage of a steam turbine of a combined cycle power generation system.

In another embodiment, a method for recovering exhaust heat from a gas turbine is provided. The method includes transferring heat from an exhaust gas of a gas turbine to a water source to generate superheated steam. The transfer of heat occurs within an exhaust path of the gas turbine. The method also includes delivering the superheated steam to a process for use of the superheated steam as a source of power or heat.

In yet another embodiment, a system for recovering exhaust heat from a gas turbine is provided. The system includes a superheater positionable within an exhaust path of the gas turbine. The superheater is configured to receive superheated steam from a heat recovery steam generation unit. The superheater is also configured to transfer heat from an exhaust gas of the gas turbine to the superheated steam received from the heat recovery steam generation unit. The superheater is further configured to deliver the superheated steam to a steam turbine of a combined cycle power generation system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an exemplary combined cycle power generation system which may utilize the peaking cycle exhaust heat recovery systems and methods of the present embodiments;

FIG. 2 is a schematic flow diagram of an exemplary combined cycle power generation system, including a peaking cycle gas turbine, which may utilize the peaking cycle exhaust heat recovery systems and methods of the present embodiments;

FIG. 3 is a schematic flow diagram of an exemplary combined cycle power generation system utilizing the peaking cycle exhaust heat recovery systems and methods of the present embodiments;

FIG. 4 is a schematic flow diagram of an exemplary combined cycle power generation system utilizing the peaking cycle exhaust heat recovery and attemperation systems and methods of the present embodiments;

FIG. 5 is a schematic flow diagram of an exemplary combined cycle power generation system utilizing the peaking cycle exhaust heat recovery steam generation systems and methods of the present embodiments; and

FIG. 6 is a flow diagram of an exemplary method for recovering heat from the peaking cycle gas turbine exhaust to augment the combined cycle power generation using the present embodiments.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

As discussed in detail below, exhaust heat from a peaking cycle unit, such as a peaking cycle gas turbine, may be recovered in an exhaust path of the peaking cycle unit. In particular, in certain embodiments, heated exhaust gas from a peaking cycle gas turbine may be recaptured using a low-pressure supplementary superheater in the exhaust path of the peaking cycle gas turbine. The low-pressure supplementary superheater may be used for transferring heat to a water source to generate superheated steam, which may be delivered to a steam turbine of a combined cycle power generation system. In certain embodiments, the low-pressure supplementary superheater may heat superheated steam received from an HRSG unit and, more specifically, from an evaporator of the HRSG unit. In addition, in certain embodiments, an attemperator may be used downstream of the low-pressure supplementary superheater to cool the superheated steam from low-pressure supplementary superheater whenever it exceeds a predetermined temperature level. In other embodiments, a steam generation unit may be used in the exhaust path of the peaking cycle unit for transferring heat to a separate water source to generate superheated steam.

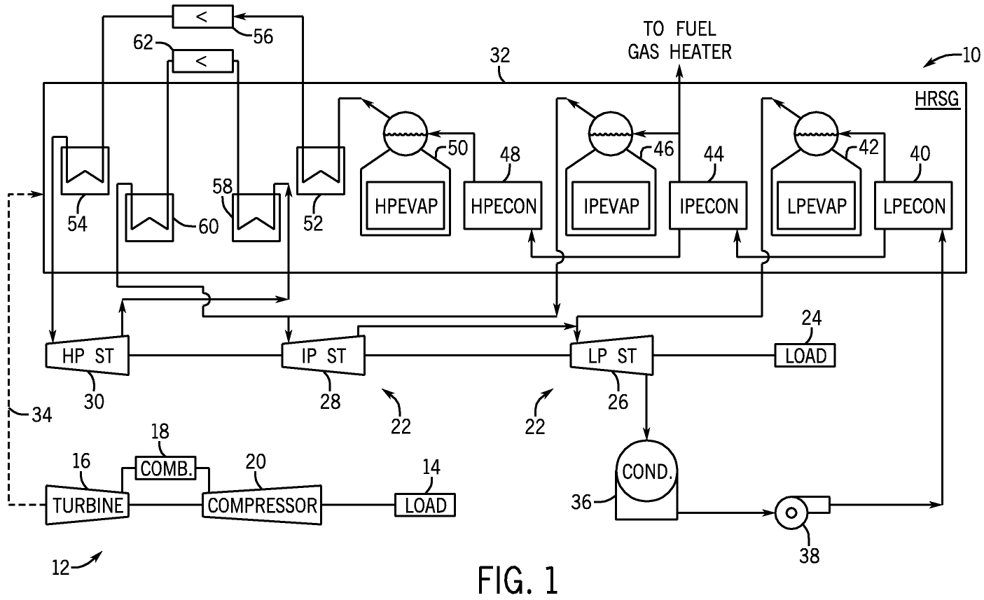

FIG. 1 is a schematic flow diagram of an exemplary combined cycle power generation system 10 which may utilize the peaking cycle exhaust heat recovery systems and methods of the present embodiments. The system 10 may include a gas turbine 12 for driving a first load 14. The first load 14 may, for instance, be an electrical generator for producing electrical power. The gas turbine 12 may include a turbine 16, a combustor or combustion chamber 18, and a compressor 20. The system 10 may also include a steam turbine 22 for driving a second load 24. The second load 24 may also be an electrical generator for generating electrical power. However, both the first and second loads 14, 24 may be other types of loads capable of being driven by the gas turbine 12 and steam turbine 22. In addition, although the gas turbine 12 and steam turbine 22 may drive separate loads 14 and 24, as shown in the illustrated embodiment, the gas turbine 12 and steam turbine 22 may also be utilized in tandem to drive a single load via a single shaft. In the illustrated embodiment, the steam turbine 22 may include one low-pressure stage 26 (LP ST), one intermediate-pressure stage 28 (IP ST), and one high-pressure stage 30 (HP ST). However, the specific configuration of the steam turbine 22, as well as the gas turbine 12, may be implementation-specific and may include any combination of stages.

The system 10 may also include a multi-stage HRSG 32. The components of the HRSG 32 in the illustrated embodiment are a simplified depiction of the HRSG 32 and are not intended to be limiting. Rather, the illustrated HRSG 32 is shown to convey the general operation of such HRSG systems. Heated exhaust gas 34 from the gas turbine 12 may be transported into the HRSG 32 and used to heat steam used to power the steam turbine 22. Exhaust from the low-pressure stage 26 of the steam turbine 22 may be directed into a condenser 36. Condensate from the condenser 36 may, in turn, be directed into a low-pressure section of the HRSG 32 with the aid of a condensate pump 38.

The condensate may then flow through a low-pressure economizer 40 (LPECON), which is a device configured to heat feedwater with gases, may be used to heat the condensate. From the low-pressure economizer 40, the condensate may either be directed into a low-pressure evaporator 42 (LPEVAP) or toward an intermediate-pressure economizer 44 (IPECON). Steam from the low-pressure evaporator 42 may be returned to the low-pressure stage 26 of the steam turbine 22. Likewise, from the intermediate-pressure economizer 44, the condensate may either be directed into an intermediate-pressure evaporator 46 (IPEVAP) or toward a high-pressure economizer 48 (HPECON). In addition, steam from the intermediate-pressure economizer 44 may be sent to a fuel gas heater (not shown) where the steam may be used to heat fuel gas for use in the combustion chamber 18 of the gas turbine 12. Steam from the intermediate-pressure evaporator 46 may be sent to the intermediate-pressure stage 28 of the steam turbine 22. Again, the connections between the economizers, evaporators, and the steam turbine 22 may vary across implementations as the illustrated embodiment is merely illustrative of the general operation of an HRSG system that may employ unique aspects of the present embodiments.

Finally, condensate from the high-pressure economizer 48 may be directed into a high-pressure evaporator 50 (HPEVAP). Steam exiting the high-pressure evaporator 50 may be directed into a primary high-pressure superheater 52 and a finishing high-pressure superheater 54, where the steam is superheated and eventually sent to the high-pressure stage 30 of the steam turbine 22. Exhaust from the high-pressure stage 30 of the steam turbine 22 may, in turn, be directed into the intermediate-pressure stage 28 of the steam turbine 22, and exhaust from the intermediate-pressure stage 28 of the steam turbine 22 may be directed into the low-pressure stage 26 of the steam turbine 22.

An inter-stage attemperator 56 may be located in between the primary high-pressure superheater 52 and the finishing high-pressure superheater 54. The inter-stage attemperator 56 may allow for more robust control of the exhaust temperature of steam from the finishing high-pressure superheater 54. Specifically, the inter-stage attemperator 56 may be configured to control the temperature of steam exiting the finishing high-pressure superheater 54 by injecting cooler feedwater spray into the superheated steam upstream of the finishing high-pressure superheater 54 whenever the exhaust temperature of the steam exiting the finishing high-pressure superheater 54 exceeds a predetermined value.

In addition, exhaust from the high-pressure stage 30 of the steam turbine 22 may be directed into a primary re-heater 58 and a secondary re-heater 60 where it may be re-heated before being directed into the intermediate-pressure stage 28 of the steam turbine 22. The primary re-heater 58 and secondary re-heater 60 may also be associated with an inter-stage attemperator 62 for controlling the exhaust steam temperature from the re-heaters. Specifically, the inter-stage attemperator 62 may be configured to control the temperature of steam exiting the secondary re-heater 60 by injecting cooler feedwater spray into the superheated steam upstream of the secondary re-heater 60 whenever the exhaust temperature of the steam exiting the secondary re-heater 60 exceeds a predetermined value.

In combined cycle systems such as system 10, hot exhaust may flow from the gas turbine 12 and pass through the HRSG 32 and may be used to generate high-pressure, high-temperature steam. The steam produced by the HRSG 32 may then be passed through the steam turbine 22 for power generation. In addition, the produced steam may also be supplied to any other processes where superheated steam may be used. The gas turbine 12 generation cycle is often referred to as the “topping cycle” whereas the steam turbine 22 generation cycle is often referred to as the “bottoming cycle.” By combining these two cycles as illustrated in FIG. 1, the combined cycle power generation system 10 may lead to greater efficiencies in both cycles. In particular, exhaust heat from the topping cycle may be captured and used to generate steam for use in the bottoming cycle.

During certain periods of operation, the total power required by loads 14, 24 of the combined cycle power generation system 10 may become too great for the bottoming and topping cycles to handle under normal operating parameters. These periods are typically referred to as peak load periods. During these periods, supplementary power techniques may be implemented to ensure that the combined cycle power generation system 10 may meet peak loading output requirements. Several supplementary power techniques may be implemented. For example, the power output from the topping cycle may be increased by, for instance, increasing the amount of fuel gas burned within the combustion chamber 18 of the gas turbine 12. Alternatively, the power output from the bottoming cycle may be increased by, for instance, increasing steam production (e.g., using supplemental fired boilers, duct burning systems, and so forth) from the HRSG 32 and associated equipment for use in the steam turbine 22. However, many of these techniques may simply involve temporarily extending the existing equipment beyond its normal operating parameters. These types of peak loading techniques, if used too often, may adversely affect the overall life of the equipment. Therefore, another commonly-used technique for peak loading may be the use of dedicated peaking cycle units, which may temporarily be activated during periods where peak loading occurs. Since they are often stand-alone units, these peaking cycle units may often be any type of power generating units capable of utilizing various power sources, including coal, gas, other fuels, electricity, and so forth. For instance, stand-alone gas turbine units may be used to meet peak load power requirements.

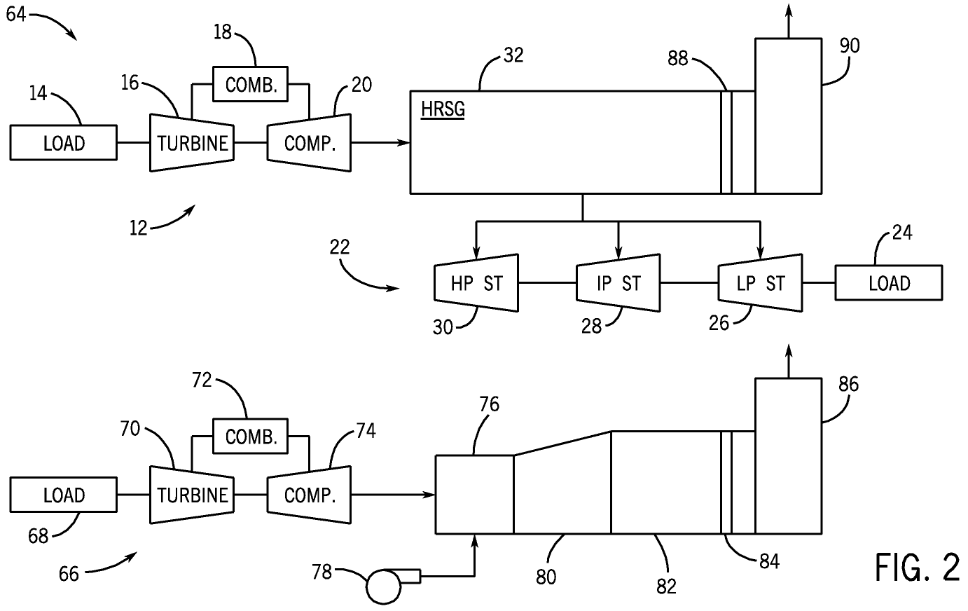

FIG. 2 is a schematic flow diagram of an exemplary combined cycle power generation system 64, including a peaking cycle gas turbine 66, which may utilize the peaking cycle systems and methods of the present embodiments. As illustrated in FIG. 2, the main bottoming and topping cycles may still be used to drive loads 14 and 24. However, in this embodiment, the peaking cycle gas turbine 66 may also be used to drive a supplementary load 68 (e.g., generator), which may be used to meet peak load power requirements. As with the main topping cycle, the peaking cycle gas turbine 66 may include a turbine 70, a combustor or combustion chamber 72, and a compressor 74. During periods of peak loading, supplemental fuel gas may be burned within the combustion chamber 72 to power the peaking cycle gas turbine 66 and, therefore, drive the supplementary load 68 (e.g., generator). The supplemental fuel gas may be from the same fuel gas source used in the main gas turbine 12. However, the supplemental fuel gas may also be from a different source and may, in fact, be a different type of fuel gas entirely.

With respect to the peaking cycle gas turbine 66, the heated exhaust gas may not be directed into a complimentary bottoming cycle, as is the case with the main gas turbine 12. As such, the heated exhaust gas from the peaking cycle gas turbine 66 may be processed in an entirely different manner than from the main gas turbine 12. In particular, since the heat (and, more specifically, energy) of the exhaust gas from the peaking cycle gas turbine 66 may not be recaptured by a complimentary bottoming cycle, the temperature of the exhaust gas may remain higher than desired. For instance, it may be desirable to lower the temperature of the heated exhaust gas so that it may be safely vented downstream of the peaking cycle gas turbine 66. In addition, the exhaust gas may also be processed in order to reduce undesirable exhaust emissions (e.g., NOₓ). Selective catalytic reduction (SCR) may be used for reducing NOₓ concentrations in exhaust gases from gas turbines. However, this process requires the use of SCR catalysts, which may be more expensive and less reliable at higher temperatures. As such, it may prove advantageous to reduce the temperature of exhaust gases from gas turbines before using SCR catalysts to reduce NOₓ concentrations in the exhaust gases.

Accordingly, the heated exhaust gas from the peaking cycle gas turbine 66 may first be directed into an exhaust duct 76 where a blower 78 or other external cooling devices may be used to cool the exhaust gas to more manageable exhaust temperature levels. After being cooled by the blower 78, the exhaust gas may then be directed into an expansion duct 80, where the exhaust gas may be allowed to expand. Next, the exhaust gas may be directed into a main peaking cycle duct 82, which may include the SCR equipment 84 using SCR catalysts to reduce the NOₓ concentrations of the exhaust gas. From the main peaking cycle duct 82, the exhaust gas may finally be directed into the peaking cycle stack 86 before being vented to the surrounding environment at lower temperatures and NOₓ concentrations. It should be noted that the HRSG 32 of the main system may also include similar SCR equipment 88, upstream of a stack 90 of the HRSG 32, which may also utilize SCR catalysts to reduce NOₓ concentrations of the exhaust gas through the main combined cycle power generation system.

Although the blower 78, SCR equipment 84, and other equipment may be used to adequately reduce the temperature levels and NOₓ concentrations of the exhaust gas from the peaking cycle gas turbine 66, the use of these techniques may not prove to be the most efficient design. For instance, heat from the exhaust gas is not recaptured with these techniques. In addition, the blower 78 or other cooling devices may exact an auxiliary power penalty, thereby reducing the overall efficiency of the peaking cycle system. Moreover, the peaking cycle gas turbine 66 may often be of a type which inherently operates at lower efficiencies. For instance, the efficiencies of such units may typically be in the range of only 35-40%. In addition, although the exhaust gas may be cooled to a certain extent by the blower 78, high-temperature SCR catalysts may still be required. As mentioned above, these SCR catalysts may often be less reliable and more expensive. Therefore, it may prove beneficial to further enhance the peak loading processes of the combined cycle power generation system 64 by more effectively recovering heat from the exhaust gas of the peaking cycle gas turbine 66. Doing so may generate multiple benefits including, but not limited to, increasing the overall efficiency of the peaking cycle gas turbine 66 and related systems, eliminating the need for the blower 78 or other external cooling devices, allowing for the use of more reliable, less expensive low-temperature SCR catalysts, and so forth.

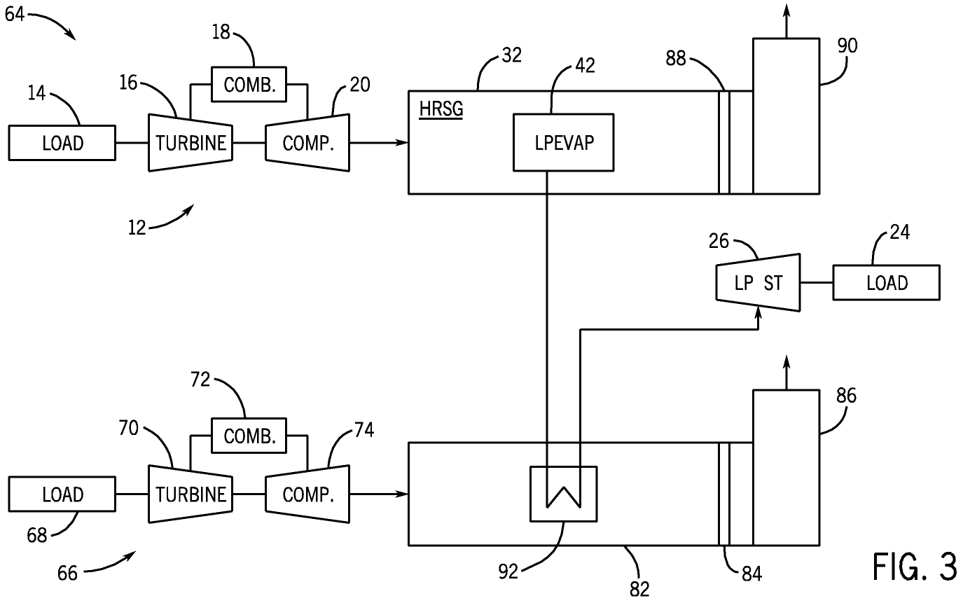

FIG. 3 is a schematic flow diagram of an exemplary combined cycle power generation system 64 utilizing the peaking cycle exhaust heat recovery systems and methods of the present embodiments. In particular, as illustrated in FIG. 3, a low-pressure supplementary superheater 92 may be used within the main peaking cycle duct 82 in the exhaust path of the peaking cycle gas turbine 66. During peak loading operations, the low-pressure supplementary superheater 92 may be used to provide additional heat to the superheated low-pressure steam of the combined cycle power generation system 64. In particular, superheated low-pressure steam may be received from the low-pressure evaporator 42 of the HRSG 32 by the low-pressure supplementary superheater 92 and further heated by the heated exhaust gas from the peaking cycle gas turbine 66. Thus, heat from the exhaust gas of the peaking cycle gas turbine 66 may be transferred into the superheated low-pressure steam from the low-pressure evaporator 42 of the HRSG 32 before being directed into the low-pressure stage 26 of the steam turbine 22. Specifically, for example, the temperature of the exhaust gas may be reduced from approximately 1120° F. to approximately 700° F. across the low-pressure supplementary superheater 92 whereas the temperature of the superheated steam may be increased from approximately 600° F. to approximately 1050° F. across the low-pressure supplementary superheater 92.

The heat transferred into the superheated low-pressure steam from the low-pressure evaporator 42 of the HRSG 32 may not only allow the bottoming cycle of the combined cycle power generation system 64 to generate more power but, at the same time, may reduce the temperature of the exhaust gas from the peaking cycle gas turbine 66, thereby minimizing the need for cooling of the exhaust gas as well as minimizing the use of high-temperature SCR catalysts, among other benefits. Therefore, the efficiencies of both the peaking cycle and the main combined cycle may be increased through enhanced recovery of exhaust heat from the peaking cycle gas turbine 66.

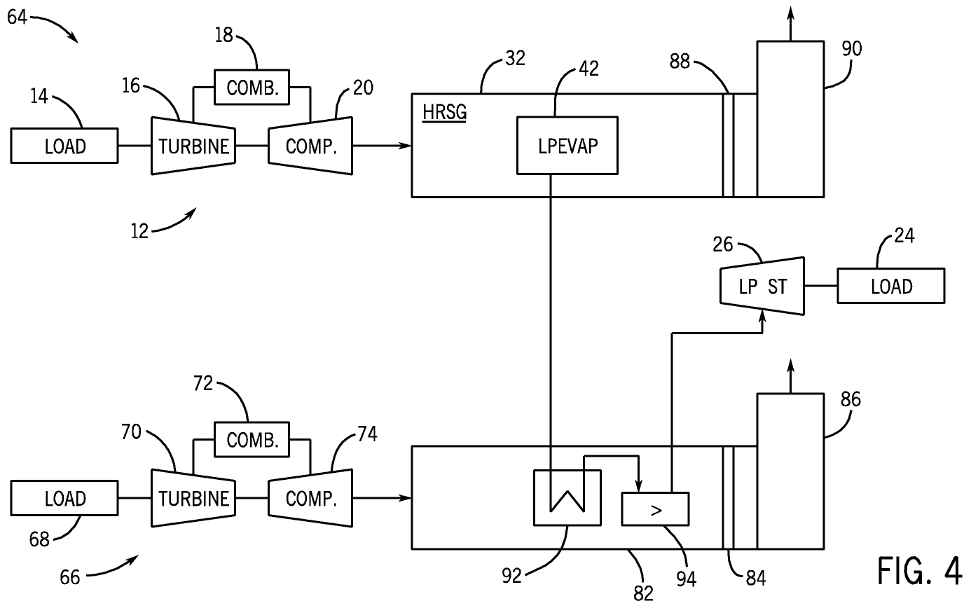

In certain embodiments, low-pressure water may be used for cooling the superheated low-pressure steam from the low-pressure supplementary superheater 92 of the main peaking cycle duct 82. For instance, FIG. 4 is a schematic flow diagram of an exemplary combined cycle power generation system 64 utilizing the peaking cycle exhaust heat recovery and attemperation systems and methods of the present embodiments. As illustrated, a low-pressure peaking cycle attemperator 94 may be used to monitor and maintain the temperature of the superheated low-pressure steam from the low-pressure supplementary superheater 92 of the main peaking cycle duct 82. In particular, low-pressure water may be used by the low-pressure peaking cycle attemperator 94 to cool the superheated low-pressure steam whenever it reaches temperatures exceeding a pre-determined temperature level. This predetermined temperature level may, for instance, be selected based on metallurgical limits of the low-pressure stage 26 of the steam turbine 22 and associated equipment.

As such, an advantage of the low-pressure peaking cycle attemperator 94 may be to allow for maximum heat recovery from the exhaust gas of the peaking cycle gas turbine 66, while also enabling sufficient protection of the low-pressure stage 26 of the steam turbine 22 and its associated equipment. In other words, the low-pressure supplementary superheater 92 may ensure that the maximum heat recovery from the exhaust gas is realized. However, in doing so, the temperature of the superheated low-pressure steam downstream of the low-pressure supplementary superheater 92 may exceed the predetermined temperature level. Therefore, the low-pressure peaking cycle attemperator 94 may function as a protective device, which may ensure that the maximum heat recovery from the exhaust gas of the peaking cycle gas turbine 66 does not adversely affect the low-pressure stage 26 of the steam turbine 22 and its associated equipment. Specifically, for example, the temperature of the superheated steam may be reduced from approximately 1050° F. to approximately 600° F. across the low-pressure peaking cycle attemperator 94.

Although shown in FIG. 4 as being integrated into the main peaking cycle duct 82 for illustration purposes, the low-pressure peaking cycle attemperator 94 may actually be separate from the main peaking cycle duct 82 and, in fact, may not be integrated into any of the peaking cycle equipment. For instance, in certain embodiments, the low-pressure peaking cycle attemperator 94 may be located immediately upstream of the low-pressure stage 26 of the steam turbine 22.

In the embodiments described herein, a low-pressure supplementary superheater 92 may be used to further heat the superheated low-pressure steam from the low-pressure evaporator 42 of the HRSG 32 using the heated exhaust gas from the peaking cycle gas turbine 66. However, in other embodiments, the superheated low-pressure steam may actually be generated within the main peaking cycle duct 82 or at some other location downstream of the peaking cycle gas turbine 66 in the exhaust path of the peaking cycle.

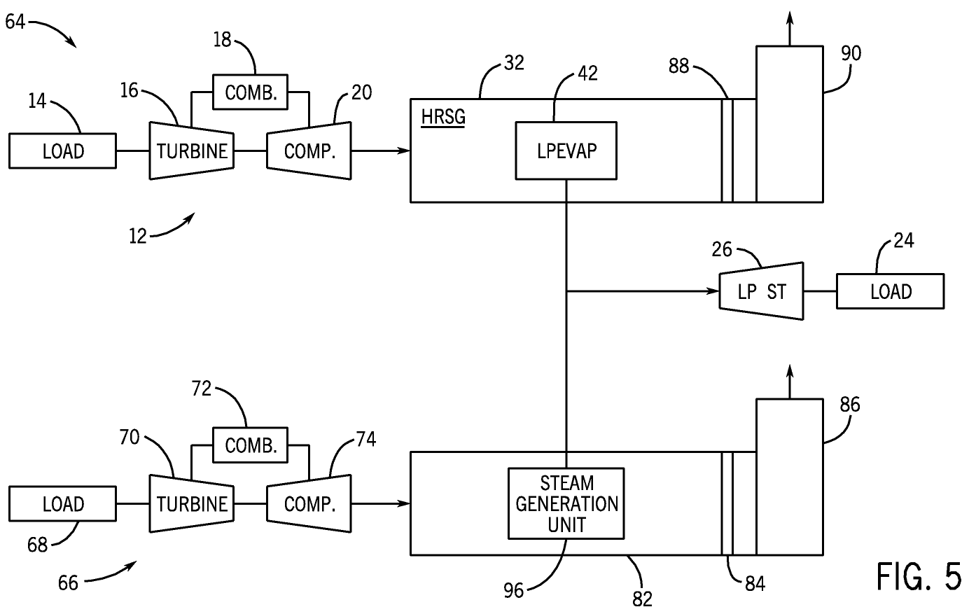

For instance, FIG. 5 is a schematic flow diagram of an exemplary combined cycle power generation system 64 utilizing the peaking cycle exhaust heat recovery steam generation systems and methods of the present embodiments. In this embodiment, a separate, once-through low-pressure steam generation unit 96 may be introduced into the exhaust path of the peaking cycle gas turbine 66. The steam generation unit 96 may, for instance, be a boiler or some combination of economizers, evaporators, superheaters, and so forth. The steam generation unit 96 may recover heat from the exhaust gas from the peaking cycle gas turbine 66 to actually create a superheated low-pressure steam flow, which may be used to supplement the superheated low-pressure steam flow from the low-pressure evaporator 42 of the HRSG 32. In this embodiment, superheated low-pressure steam generated by the steam generation unit 96 may be mixed with the superheated low-pressure steam flow from the low-pressure evaporator 42 of the HRSG 32, such that both sources of steam may be injected into the low-pressure stage 26 of the steam turbine 22 to produce additional power output.

In addition, although the embodiments described herein generally relate to recovering heat from the exhaust gas from one peaking cycle gas turbine 66 to superheat steam from one HRSG 32 unit, it may also be possible to extend these techniques to any number of combinations of peaking cycle units, HRSGs, steam turbines, and so forth. For instance, heat may be recovered from multiple peaking cycle units to superheat steam from multiple HRSG units. Furthermore, although the embodiments described herein generally relate to recovering heat from the exhaust gas from peaking cycle gas turbines 66, it may also be possible to recover heat from the exhaust of other types of peaking cycle units. For instance, heat from exhaust discharged from peaking boiler systems, among others, may also be recovered using the techniques of the present embodiments. Moreover, although the embodiments described herein generally relate to recovering heat from the exhaust gas from peaking cycle gas turbines 66, the disclosed embodiments may also be extended to any other simple cycle (i.e., not combined cycle) gas turbines.

Moreover, the embodiments described herein generally relate to delivering the superheated steam generated by the low-pressure supplementary superheater 92 in FIGS. 3 and 4 and the steam generation unit 96 in FIG. 5 to steam turbines of the combined cycle power generation system 64, such as the steam turbine 22. However, it should be noted that the generated superheated steam may also be used in other processes where superheated steam may provide a source of power or heat.

In addition, the peaking cycle heat recovery techniques described herein may be applied not only to new peaking cycle units, but also to simple cycle units already being used for meeting peak load requirements. In other words, the systems for implementing the peaking cycle heat recovery techniques may be installed as stand-alone packages, which may be retrofit into the exhaust paths of existing peaking cycle units. For example, with respect to the embodiments of FIGS. 3 and 4, the low-pressure supplementary superheater 92 (and optional low-pressure peaking cycle attemperator 94) may be installed into the main peaking cycle duct 82, or another location downstream of the peaking cycle gas turbine 66. In this embodiment, suitable connections may be retroactively installed between the heat recovery equipment (e.g., the low-pressure supplementary superheater 92 and the optional low-pressure peaking cycle attemperator 94), the low-pressure evaporator 42 of the HRSG 32, and the low-pressure stage 26 of the steam turbine 22.

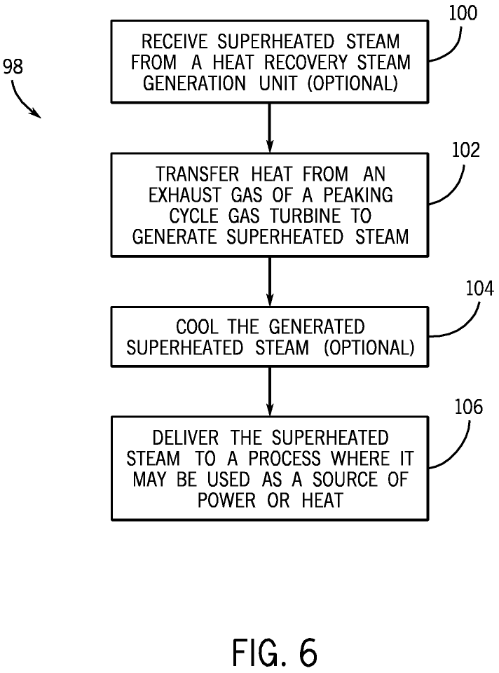

Regardless of the particular configurations used, the methods for utilizing the peaking cycle heat recovery techniques described herein may generally be substantially similar. FIG. 6 is a flow diagram of an exemplary method 98 for recovering heat from the peaking cycle gas turbine 66 exhaust to augment the combined cycle power generation using the present embodiments. At step 100, superheated steam may be received from the HRSG 32. In particular, low-pressure superheated steam may be received from the low-pressure evaporator 42 of the HRSG 32. As discussed above with respect to FIG. 5, step 100 may actually be optional in that, if the separate, once-through low-pressure steam generation unit 96 is used, no superheated steam from the HRSG 32 need be supplied. Rather, the steam generation unit 96 of FIG. 5 may use the exhaust gas from the peaking cycle gas turbine 66 to heat water from a separate water source in order to generate its own superheated steam. However, in the embodiments described in FIGS. 3 and 4 where the low-pressure supplementary superheater 92 is used, low-pressure superheated steam from the low-pressure evaporator 42 of the HRSG 32 may be received and further heated by the low-pressure supplementary superheater 92.

At step 102, heat from the exhaust gas of the peaking cycle gas turbine 66 may be transferred to a water source to generate superheated steam, wherein the transfer of heat occurs within an exhaust path of the peaking cycle gas turbine 66. As discussed above with respect to step 100, step 102 may be accomplished by various arrangements and embodiments. In the embodiments described in FIGS. 3 and 4, additional heat may be transferred to the superheated steam from the HRSG 32 by the low-pressure supplementary superheater 92 in the exhaust path of the peaking cycle gas turbine 66. However, in the embodiment described in FIG. 5, a separate water source may be superheated by the steam generation unit 96 in the exhaust path of the peaking cycle gas turbine 66. In either case, the heat used to generate the superheated steam may be transferred from that exhaust gas of the peaking cycle gas turbine 66.

At step 104, the generated superheated steam may be cooled. In particular, the low-pressure peaking cycle attemperator 94 may be used to cool the superheated steam whenever the superheated steam exceeds a predetermined temperature level which may, for instance, be selected based on metallurgical limits of the low-pressure stage 26 of the steam turbine 22 and associated equipment. Step 104 is optional and may be selected for use in situations where, for instance, there is a possibility that the heat recovery from the exhaust gas of the peaking cycle gas turbine 66 may lead to excessive temperature levels downstream of the heat recovery equipment.

At step 106, the superheated steam may be delivered to a process where it may be used as a source of power or heat. In particular, the superheated steam may be delivered to a steam turbine (e.g., the low-pressure stage 26 of the steam turbine 22) of the combined cycle power generation system 64, where the superheated steam may be used as a source of power. However, as described herein, the process may also include any processes where superheated steam may be used as a source of power or heat. These processes may typically be other processes within the plant where the combined cycle power generation system 64 is located.

Therefore, the present embodiments provide for systems and methods for augmenting combined cycle power generation by enhancing the recovery of heat from the exhaust gases of a peaking cycle unit, such as the peaking cycle gas turbine 66. More specifically, the present embodiments are directed toward systems and methods for recapturing the heat from the exhaust gases of the peaking cycle gas turbine 66 in an exhaust path just downstream of the peaking cycle gas turbine 66. Since the exhaust heat recovery equipment (e.g., low-pressure supplementary superheater 92) may be located in an exhaust path of the peaking cycle gas turbine 66, the requirements for re-sizing other equipment of the combined cycle power generation system 64 (e.g., components of the main topping and bottoming cycles) are minimized. For example, instead of injecting the exhaust gas from the peaking cycle gas turbine 66 into the main HRSG 32, which would require re-sizing of piping and other various equipment of the HRSG 32, isolating the low-pressure supplementary superheater 92 within an exhaust path of the peaking cycle gas turbine 66 may eliminate the need for re-sizing the HRSG 32 piping and associated equipment to accommodate increased flow rates through the HRSG 32. Similarly, by allowing direct delivery of the superheated steam to the steam turbine 22, re-sizing of piping and associated equipment may be minimized. However, the connections used to deliver the superheated steam from, for instance, the low-pressure supplementary superheater 92 (and optional low-pressure peaking cycle attemperator 94) may involve slight re-sizing to accommodate the increased steam flow rate and associated increased temperature of the steam flow into the steam turbine 22.

As described herein, other benefits may also be realized using the present embodiments. For instance, by delivering the superheated steam to the steam turbine 22 of the combined cycle power generation system 64, as opposed to a stand-alone, single-pressure steam turbine, the overall efficiency of the combined cycle power generation system 64 may be increased significantly. In addition, by transferring a certain amount of heat from the exhaust gas of the peaking cycle gas turbine 66 to the superheated steam, the temperature of the exhaust gases downstream of the heat recovery equipment (e.g., the low-pressure supplementary superheater 92 in FIGS. 3 and 4 or steam generation unit 96 in FIG. 5) may be significantly reduced, thereby reducing or eliminating the need for separate cooling equipment as well as allowing for the use of more reliable, less expensive low-temperature SCR catalysts in order to reduce NOₓ emissions.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for recovering exhaust heat from a gas turbine, comprising:
receiving superheated steam from a low-pressure evaporator of a heat recovery steam generation unit;
transferring heat from an exhaust gas of a gas turbine to the superheated steam received from the low-pressure evaporator using a low-pressure supplementary superheater in an exhaust path of the gas turbine; and
delivering the superheated steam to a low-pressure stage of a steam turbine of a combined cycle power generation system.

2. The method of claim 1, comprising cooling the superheated steam using a low-pressure attemperator.

3. A method for recovering exhaust heat from a gas turbine, comprising:
transferring heat from an exhaust gas of a gas turbine to a water source to generate superheated steam, wherein the transfer of heat occurs within an exhaust path of the gas turbine; and
delivering the superheated steam to a process for use of the superheated steam as a source of power or heat.

4. The method of claim 3, comprising receiving superheated steam from a heat recovery steam generation unit.

5. The method of claim 4, comprising transferring heat from the exhaust gas to the superheated steam received from the heat recovery steam generation unit.

6. The method of claim 4, comprising receiving superheated steam from an evaporator of the heat recovery steam generation unit.

7. The method of claim 6, comprising receiving superheated steam from a low-pressure evaporator of the heat recovery steam generation unit.

8. The method of claim 3, wherein transferring heat comprises transferring heat from the exhaust gas to a low-pressure supplementary superheater in the exhaust path of the gas turbine.

9. The method of claim 3, wherein transferring heat comprises transferring heat from the exhaust gas to a once-through low-pressure steam generation unit in the exhaust path of the gas turbine.

10. The method of claim 3, comprising cooling the generated superheated steam.

11. The method of claim 10, comprising cooling the generated superheated steam using an attemperator.

12. The method of claim 3, wherein delivering comprises delivering the superheated steam to a steam turbine of a combined cycle power generation system.

13. The method of claim 12, comprising delivering the superheated steam to a low-pressure stage of the steam turbine.

14. A system for recovering exhaust heat from a gas turbine, comprising:
a superheater positionable within an exhaust path of the gas turbine, wherein the superheater is configured to:
receive superheated steam from a heat recovery steam generation unit;
transfer heat from an exhaust gas of the gas turbine to the superheated steam received from the heat recovery steam generation unit; and
deliver the superheated steam to a steam turbine of a combined cycle power generation system.

15. The system of claim 14, comprising an attemperator configured to cool the superheated steam whenever the superheated steam exceeds a predetermined temperature level.

16. The system of claim 14, wherein the superheater is a low-pressure superheater.

17. The system of claim 16, wherein the superheater is configured to receive low-pressure superheated steam from a low-pressure evaporator of the heat recovery steam generation system unit.

18. The system of claim 17, wherein the superheater is configured to deliver the low-pressure superheated steam to a low-pressure stage of the steam turbine.

19. The system of claim 14, comprising a plurality of superheaters, wherein the plurality of superheaters are configured to: receive superheated steam from a plurality of heat recovery steam generation units, receive exhaust gas from a plurality of gas turbines, deliver superheated steam to a plurality of steam turbines, or a combination thereof.

20. The system of claim 14, wherein the superheater is configured to be retrofit into exhaust paths of existing gas turbines.
